(19) United States
(12) Patent Application Publication
(10) Pub. No.: US 2006/0087425 A1
(43) Pub. Date: Apr. 27, 2006

(54) System and method for localization over a wireless network

(75) Inventors: Andreas Haeberlen, Saarbruecken (DE); Andrew M. Ladd, Houston, TX (US); Daniel S. Wallach, Houston, TX (US); Eliot J. Flannery, Redmond, WA (US); Algis P. Rudys, Mountain View, CA (US); Lydia E. Kavraki, Houston, TX (US)

Correspondence Address: Roger Fulghum;Baker Botts L.L.P., One Shell Plaza, 910 Louisiana Street, Houston, TX, 77002-4995, US

(73) Assignee: WILLIAM MARSH UNIVERSITY

(21) Appl. No.: 11/180,030

(22) Filed: Jul. 12, 2005

Related U.S. Application Data
(60) Provisional application No. 60/587,301, filed on Jul. 12, 2004.

(51) Int. Cl. G08B 1/08; H04Q 7/20; G08B 25/00; G08B 1/00

(52) U.S. Cl. 340/539.13; 455/456.1; 340/539.2; 340/525

(57) ABSTRACT

A system for locating a wireless device involves the use of the measured signal strength of various base stations in the building or outdoor area under analysis. A topological map of the building or outdoor area under analysis is created. The map is divided into cells, and signal intensities are collected in each cell. For each cell, the signal from a particular base station is fit to a statistical distribution, such as a Gaussian distribution, and the parameters of the statistical distribution are estimated. After a device obtains a set of signal strength measurements, a probabilistic technique is employed to estimate the probability of the existence of the measurements in each of the cells of the building or area under analysis. The estimated location is the cell with the highest probability. A mobile user is tracked with the use of a Markov chain and the system can be calibrated to account for equipment and environmental variations.

### CROSS-REFERENCE TO RELATED APPLICATIONS

This application claims the benefit of U.S. Provisional Application No. 60/587,301, filed Jul. 12, 2004, which is incorporated herein by reference.

### TECHNICAL FIELD OF THE INVENTION

The present disclosure relates generally to the field of computer systems and localization techniques.

### BACKGROUND OF THE INVENTION

A practical scheme for mobile device location awareness has long been a target of mobility research. Known location sensing schemes have involved or have been characterized by specialized hardware, lengthy training steps, or poor precision. Previous location aware schemes have often involved the step of dividing the environment into a coordinate grid, followed by the step of attempting to map a device's location to a geometric point on that grid. These systems involve lengthy training, or testing and calibration at each point in the grid to achieve usable accuracy. These known systems attempted to identify with some precision the geometric location of the device or object.

### SUMMARY OF THE INVENTION

In accordance with the present disclosure, a localization system in the location of a wireless device is determined on the basis of the measured signal strength of various base stations in the building or outdoor area under analysis. A topological map of the building or outdoor area under analysis is created. The map is divided into cells, and signal intensities are collected in each cell. For each cell, the signal from a particular base station is fit to a statistical distribution, such as a Gaussian distribution, and the parameters of the statistical distribution are estimated. After a device obtains a set of signal strength measurements, a probabilistic technique is employed to estimate the probability of the existence of the measurements in each of the cells of the building or area under analysis. The estimated location is the cell with the highest probability. A mobile user is tracked with the use of a Markov chain and the system can be calibrated to account for equipment and environmental variations.

The disclosed localization system is technically advantageous because its acts on the cells of a building, with each cell being the approximate size of an office. Using a cell that is the size of an office results in a reduction in the time necessary to train all of the points of the building or area, while maintaining sufficient room or region-level granularity for most location-aware applications. Because the system involves a coarser granularity with respect to the size or each cell, localization may be performed with faster data samples and thereby operate at a faster frame rate.

Approximating the signal strength distribution with a Gaussian fit also has a number of technical advantages. First, fitting the data to a Gaussian statistical distribution only requires storing two numbers for each base station and location. The lower data requirements increases the speed and reduces the memory requirements for localization, making the localization technique more suitable for low-power embedded devices that may not have the resources of a modern laptop computer. This, a Gaussian distribution tends to provide roughly the same accuracy of localization with a reduced training effort.

The localization system disclosed herein is also advantageous in that it accounts for mobile devices through the implementation of hidden Markov chains. The Markov chains allow for the prediction of user movement through a set of rules that dictate the basis topological facts of the building or area under analysis. In addition, the localization system described herein can be calibrated to permit the system to work with previously unknown user hardware and time-varying environmental effects. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a topographical map of a building;

FIG. 2 is a floor plan of a building and a Markov chain that demonstrates the options for a user to travel within the rooms or cells of the building;

FIG. 3 is a flow diagram of a series of steps in the training of a localization system; and

FIG. 4 is a flow diagram of the steps for predicting the location of a wireless device.

### DETAILED DESCRIPTION

The disclosed invention involves the creation of a topological map for localization. The disclosed invention involves the determination of a location of a device from the measured signal strength of various base stations in a given building or region. A topological map models the environment as a graph, with each node representing a region (such as a particular room or corridor), and each edge representing regions that are connected in space. The invention is described herein with respect to a localization framework and is described with respect to deployment results in an office building or in a defined outdoor area. The disclosed localization system use Markov localization and involves the collection of signal intensity measurements for whole offices and hallways, treating the entire office or hallway as a single position. The distribution of signal intensities for each base station is then fit to a normal distribution. The localization technique that is described herein may use an existing signal intensity meter of a mobile device. One example is the built-in signal intensity meter of wireless Ethernet cards.

Comparatively little data is necessary to build the signal or sensor map of the present invention. The localization system described herein can be trained by spending as little as one minute per office or region, walking from region to region with a laptop or other device and recording the observed signal intensities of the transmitting stations of the building. The result of the training measurements is a large data set with several dozen data points per cell per base station. In each cell, the signal from a particular base station follows approximately a Gaussian distribution. In a post-processing step, the parameters of these Gaussian distributions are estimated from the data set. The result is the average signal strength and the standard deviation for each cell and base station. Together, these values form a signal map of the building or outdoor area under analysis. Using the signal map, a device can then estimate its own position in the building. First, it obtains a set of signal strength measurements, using the built-in signal strength meter of standard wireless hardware. Then it uses a probabilistic technique (Bayesian localization) to estimate the probability of having seen these measurements in each of the cells. The estimated location is the cell with the highest probability. The estimate can be further refined using more measurements; typically, five measurements are sufficient to find the correct cell.

The localization system described herein also provides for the ability to tracking a moving device. The disclosed localization system involves the use of a Markov chain to update the probabilities between two steps. The Markov chain encodes basic topological facts about the building, including rules that one cannot pass through walls except via doors, and one cannot switch floors except via staircases. In addition, the localization system described herein can be calibrated to permit the system to work with previously unknown user hardware. The localization system described herein is sufficiently robust to enable a variety of location-aware applications without requiring special-purpose hardware or complicated training and calibration procedures.

It is recognized herein that most, if not all, location-aware applications do not need one to two meter precision for the location of a mobile device. By using a topological model of our environment, each building or outdoor area can be divided into cells that map to a region in the building or outdoor area. In the case of a building, each cell could map to a specific office or segment of hallway. In the case of an outdoor area, each cell could map to an area of similar size. By mapping a device's location to a cell instead of to a point, some metric resolution is exchanged for a dramatic reduction in training time. Room or region-level granularity of location provides sufficient context for most location-aware applications. Additionally, operating at a coarser granularity leads to an improvement in localization robustness, and allows localization to occur with fewer samples, and thus operate at a faster frame rate.

The localization technique described herein involves the use of a high-precision topological location inference technique based on Bayesian inference and using 802.11b wireless Ethernet. Following a training time of approximately 60 seconds per room or cell, the technique is operable to localize a device to a cell within seconds. The system described herein can compensate for time-of-day variations, including the presence or absence or large groups of people in the same room as the platform being localized. In addition, the system described herein allows for the calibration and use of wireless Ethernet implementations different from the system used to initially measure the building. Also, the techniques disclosed herein support both static localization and dynamic tracking of mobile devices.

The localization system described herein is based on a wireless communications system, one example of which is 802.11b wireless Ethernet, which is inexpensive and widely deployed on college campuses and in commercial offices. Most new laptop computers and personal digital assistants (PDAs) have built-in support for 802.11b wireless communications. 802.11b wireless communication involves the use of 11 channels in the 2.4 GHz industrial, scientific, and medical (ISM) band. In a wireless communications environment, client-side wireless hardware measures signal intensity from base stations to determine the best base station with which to associate. This function is also performed by client-side wireless hardware operating according to the 802.11 specification. The wireless Ethernet card of the client-side devices tunes into each channel in turn, sends a ProbeRequest packet and logs any corresponding ProbeResponse packets it receives. Transmitting a ProbeRequest packet and received a ProbeResponse packet for each of the eleven channels can be completed in approximately one second. The localization system described herein uses the signal intensities observed at the wireless device from the step of completing a ProbeRequest packet and receiving a ProbeResponse packet for each of the eleven channels associated with a wireless device.

The process of determining the location of a device or agent involves determining an agent's state (or position) s*, given one or more observations. This relationship can be modeled by using a finite state space S={s₁, . . . ,sₙ} and a finite observation space O={o₁, . . . ,oₘ}. In a probabilistic localization framework, the agent's estimate of its state is represented as a probability distribution [symbol] over S, where [symbol] ᵢ=P(sᵢ=s*). This method is useful since it can quantify the uncertain relationship between state and observation. In the Markov localization (ML) approach, the probability distribution over the observation space is determined completely by the current state. In particular, the relationship between state and observation can be represented by a matrix of conditional probabilities which encode the probability of observing oⱼεO given that the agent is in state sᵢ, which is written P(oⱼ/sᵢ). This matrix of conditional probabilities is referred to as the sensor model. As an example, if the agent has a prior estimate π of its state and observes oⱼ. An updated estimate π′ is computed by Bayes Rule as follows:

$$\begin{matrix}η = {\sum }_{i = 1}^{n} P ( {o}_{j} \vert {s}_{i} ) {\vec{π}}_{i} . & ( Equation 1 ) \\ {\vec{π}}_{i}^{′} = \frac{P ( {o}_{j} \vert {s}_{i} ) {\vec{π}}_{i}}{η} . & ( Equation 2 )\end{matrix}$$

The quantity η is the normalizer for the estimate and is sometimes referred to as the confidence. The confidence value can be used to quantify the certainty of the new position estimate. In particular, the confidence value can be used for several different algorithmic extensions to Markov localization. By examining the confidence value, the localizer can choose between several different strategies in the case where one strategy is failing systematically. Important examples include a sensor resetting localizer and various hybrid Monte Carlo localizers.

The localization system of the present invention involves the setting of a set B {b₁, . . . ,bₖ} of base stations and a set V={0, . . . ,255} of signal intensity values. The observation set consists of O=B×V. The signal intensity is modeled as a normal distribution determined by the state and base station. Given state sᵢ and base station bⱼ, the signal intensity distribution is determined by its mean μ_{i,j} and standard deviation σ_{i,j}. The probability of observing (bⱼ, ν)εO at state sᵢ is given by

$$\begin{matrix}{G}_{i , j} ( v ) = {\int }_{v - 1 / 2}^{v + 1 / 2} \frac{{ⅇ}^{- ( x - {μ}_{i , j} ) / ( 2 {σ}_{i , j}^{2} )}}{{σ}_{i , j} \sqrt{2 π}} ⅆ x \\ and & ( Equation 3 ) \\ P ( ( {b}_{j} , v ) \vert {s}_{i} ) = \frac{{G}_{i , j} ( v ) + β}{{N}_{i , j}} , & ( Equation 4 )\end{matrix}$$

where β is small constant used to represent the probability of observing an artifact and N_{i,j} is a normalizer such that:

$${\sum }_{v = 0}^{255} P ( ( {b}_{j} , v ) \vert {s}_{i} ) = 1. \qquad ( Equation 5 )$$

Localization with wireless Ethernet may involve the application of the sensor model explicitly. In this explicit model, each P(oⱼ/sᵢ) is stored in a table, and this method is known as the histogram method, as, for each sᵢ, the P(oⱼ/sᵢ) are determined by the normalized signal intensity histograms recorded during the training phase. The histogram model can accurately represent non-Gaussian signal intensity distributions that can only be grossly summarized by a best-fit Gaussian curve. The use of a histogram model may not provide increased localization accuracy.

In operation, the localization system described herein will typically employ multiple wireless base stations and wireless devices. As an example, the wireless base stations may comprise Cisco Aironet 1200 Series base stations with 802.11a/b support, and the wireless devices may comprise D-Link AirPlus DWL650+WLAN PCMCIA cards using the Texas Instruments ACX100 chipset installed in a Dell Latitude X200 laptop running the Linux 2.4.25 kernel and an IBM Thinkpad T40p running the Linux 2.4.20 kernel. The driver for the wireless cards may comprise an open-source ACX100 driver from SourceForge, for example.

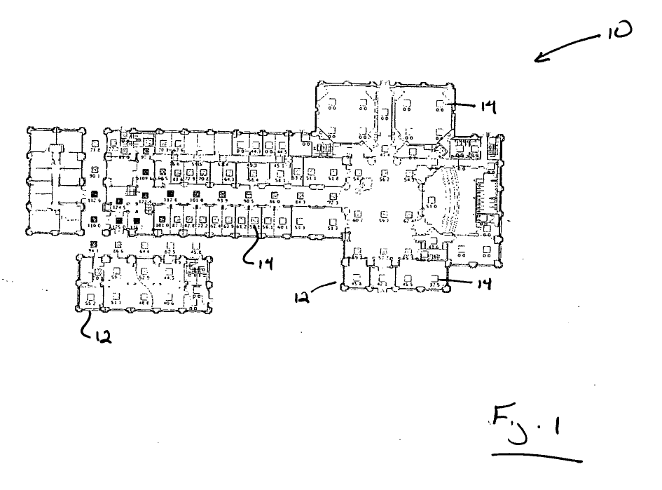

In operation, the region or building under analysis should be divided topologically into a number of cells. Depending on office size, there may be one cell per office. For larger areas or rooms, such as conference rooms, laboratories, and lecture halls, the standard deviation of reported signal intensities may be too high the assignment of only a single cell to the area. In this event, multiple cells are assigned different regions of each larger area or room, including multiple cells in each conference room laboratory, and lecture hall. Each cell is trained separately. For those spaces having multiple cells, the cells can be treated as a single cell for the purpose of localization. Cells can also be assigned hallway segments. Shown in FIG. 1 is an example of a topographical map of a building 10. The building includes a number of enclosed areas 12. Each defined cell of the building is shown with a dot 14. Each cell is sometimes referred to herein as a training point.

It should be appreciated that the size of a cell may vary throughout the building under analysis. In one example, the size of a typical office, which includes only a single cell, may be 2.74 by 4.88 meters (16 by 9 feet), and the size of the largest space that includes only a single cell could be approximately 6 by 6 meters (19.7 by 19.7 feet). A typical hallway segment, depending on the width of the hallway, could be partitioned into cells of segments approximately 5.69 meters (18.67 feet) long. Cells in outdoor locations, such as cells for balconies and entryways, could also be established and trained. To track a user as the user moves through the building, a transition graph can be constructed over the set of cells. The graph would include represent the navigable paths in the building and would reflect the fact that one cannot pass through walls and that one cannot move between floors, except through staircases and elevators, as applicable.

As described above, a number of cells are first established in topological locations in the building. Following the identification of the number of cells to be used in the building, the cells must each be trained to create a sensor map of data values for each cell of the building or area under analysis. Following the establishment of the cells, base station scans are collected for each of the cells. In one example, each cell is scanned 100 times while the person taking the measurements walked slowly around the area covered by the cell. It should be appreciated that each scan may not receive an intensity reading from each of the base stations that serve the building. The intensity values are plotted according to an intensity scale that yields a meaningful granularity to the measurement. As one example, the signal intensity could be measured along a scale from 1 (lowest intensity) to 256.

It has been observed that when the measured intensity of a scan is evaluated as a histogram, the distribution of the intensity measures falls into one of three categories. First, many of the distributions of intensity measures fall in a range that is close to a Gaussian distribution. Second, some intensity measurement distributions were sparse, indicating that the base stations were almost out of range, and yield a Gaussian distribution with a fairly large standard deviation. Third, some intensity measurement distributions were bimodal, in which the estimated mean was in the middle, with a large standard deviation. This category could be fit with a bimodal weighted Gaussian distribution, although experimentation has shown that a bimodal weight Gaussian distribution has only a marginal improvement over a single-mode estimator. When completing the scans, it will likely be observed that signal intensity degrades fairly consistently as distance increases from the base station. A wireless device may be able to get a reliable signal from a base station while outside or in a disconnected part of the building (that is, through two exterior walls and windows). A wireless device may be able to receive a reading from halfway across the building and on different floors of the building. At long distances, some cells of the building will receive a reading from a base station, while a neighboring office will not receive a reading. This phenomenon could be caused by multipath effects or by other variations in building geometry that result in favorable or unfavorable signal propagation.

When determining the location of a remote user in a building or area, it is not realistic to assume the existence of a static environment and a stationary operator. The observed signal intensity distributions will often differ from the distributions estimated in the training phase due to a myriad of time-correlated phenomena. These phenomena include environment properties such as attenuation due to people in the building or building residents opening and closing their office doors. Likewise, transient interference can be caused by other electronic devices including microwave ovens, Bluetooth devices, and cordless phones. Furthermore, a 2.4 GHz frequency corresponds to a 12.5 cm wavelength, implying that multipath fading effects may be experienced even with small changes in the operator's location. These dynamic environmental influences can cause the observed signal intensity to vary over both small and large timescales. The movement of the operator in the environment further complicates the task of maintaining an accurate position estimate.

The movement of an agent holding or carrying the device also affects the ability to identify the location of a device. Although Markov localization works well as a single-shot localization algorithm or for a stationary agent, for a moving agent, the prior position estimate will hamper correct localization. A solution can be obtained by resetting the distribution [symbol] to a uniform distribution over all states between each burst of observations. A more elegant and effective solution is to update the state estimate between each set of observations using a Markov chain that encodes assumptions about how the agent can move from state to state. Suppose at time t, the state estimate is [symbol] ^{t}. Between time t and t+1, the agent moves in some unknown way. At time t+1, the observations o₁, . . . ,oₗ are received. The state estimate at time t+1 is computed as follows:

$$\begin{matrix} {\vec{π}}^{t +} = A {{π}^{->}}^{t} \\ and & ( Equation 6 ) \\ {\vec{π}}_{i}^{t + 1} = \frac{{\prod }_{j = 1}^{l} P ( {o}_{j} \vert {s}_{i} ) {\vec{π}}_{i}^{t +}}{η} & ( Equation 7 )\end{matrix}$$

The probability matrix A encodes a Markov chain which represents an estimated, probabilistic update of the agent's position over one time step and, as before, η is a normalizer that ensures that [symbol] ^{t+1} is a probability vector.

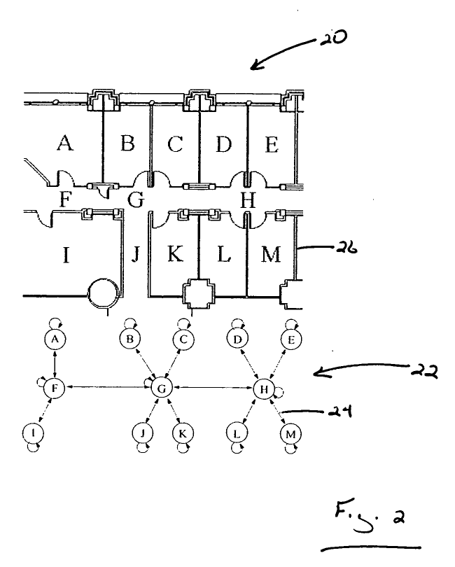

Shown in FIG. 2 is a floor plan 20 of a building and a Markov chain 22 that demonstrates the options 24 for a user to travel within the rooms or cells 26 of the building. The Markov chain recognizes that a user cannot travel through walls to reach another room or cell of the building. The probabilities for each edge transition are computed by assigning a fixed probability to the self-edge condition at each state and thereafter distributing the state's remaining probability evenly across the outgoing edges of each state. The use of a background model in connection with the localization techniques described herein increases the accuracy of the system and permits the accurate tracking of a fast-moving target. The use of a background or hidden Markov model for the movement of a user enhances the ability of the system to anticipate the movement of the user and reject unlikely measurements when the measurements would otherwise predict impossible transitions.

The sensor maps are most likely to provide for an accurate localization analysis if the hardware used by the agent is identical to the hardware used to build the sensor map. A sensor map trained with one wireless Ethernet interface can be used with another provided some calibration is done. A linear fit is efficient for adapting the sensor map to unknown new wireless Ethernet cards and other environmental changes. The differing scales of different wireless hardware are linear relations of one another. Enabling previously unknown hardware to use the location-sensing system involves discovering the linear relation, and this process can be done using linear least-squares fits. The calibration process involves a comparison of measured signal strengths to a reference signal strength.

The calibration process involves two constants, c₁ and c₂, which express how signal strength values ν_{A} from wireless card A relate to signal strength values VB from wireless card B. The relationship between ν_{A} and ν_{B} is written
ν_{A}=(ν_{B}−c₁)c₂
The constants c₁ and c₁ can be determined in a straightforward manner by searching for a best linear fit between means and standard deviations of two sensor maps taken with different hardware. This calibration can be achieved without knowing the agent's state a priori. As an example, assume that an existing sensor map for wireless card A and the agent is at unknown state and is using wireless card B. The constants c₁ and c₂ can be learned by attempting Markov localization and choosing c₁, c₂ such that the confidence, η is maximized.

With respect to calibration for time-varying effects, there is a linear relation between transmission power level and received signal strength as reported by wireless Ethernet hardware. The effect of other time-varying phenomena also appears to be linear. As a result, many time-varying phenomena can be compensated for by re-running the calibration process. A single linear-fit captures most of the deviation induced by slow timescale phenomena. Signal intensity shifts due to slow time-varying effects seem to be homogeneous on average across various locations. Running a calibration function at three or four locations in the building or area under analysis results in a localization analysis that is more stable and less prone to mistakes.

The processes of localization, tracking, and calibration can be executed simultaneously. One approach is to use a history of recent observations as a training sample to construct an estimate of the calibration parameters that are then used to process future data. This algorithm runs in parallel with the localization process. We use an expectation-maximization algorithm that computes a fixed point, iterating between inferring a sequence of location estimates from the history and then choosing c₁, c₂ to maximize the probability these estimates occurring. The observations and estimates are stored in a sliding window of between 10 and 45 seconds.

Another possible approach for simultaneous localization and calibration involves a Monte Carlo (particle filter) approach that maintains a set of c₁, c₂ hypotheses and gathers data to determine which hypothesis should be used. The Monte Carlo approach would simultaneously try a large number of hypotheses, preventing the system from becoming stuck with a local maximum and thereby missing more globally optimum settings. In this framework, the confidence values from the localizer (η) could be used to discriminate between two hypotheses.

The localization method described herein involves the fit of sensor data to a Gaussian distribution. Fitting the data to a Gaussian distribution only requires storing two numbers for each base station and location. Using a reduced data set for localization increases the speed and reduces the memory requirements for localization, making it more suitable for low-power embedded devices that may not have the resources of a modem laptop computer. Fitting to a Gaussian also provides some robustness benefits to the localization system. The use of a Gaussian distribution provides accurate localization with a reduced training effort. The use of a Gaussian fit allows for the coverage of minor modes in the Gaussian distribution curve.

Another consideration in the present invention is the selection of the size of the training set. Depending on the size of each room or location, the minimum size of a training set for a single room or location may be between 35 and 90 elements. The time required to record such a training set is approximately 60 seconds or less. The optimal size of the training set for each room or location depends on a number of factors, including building geometry, base station density, and building usage. Buildings with fewer base stations, lower base station density, or more opaque construction materials, would likely need larger training sets. Buildings with interesting or unusual geometry, such as large open areas, tend to dilute differences in signal intensity, and require more training data to train. Hallways, for example, tend to channel signals such that signal intensity drops at a regular rate going down a hallway. Large open areas tend to disperse signal, leading to much less distinction among locations. To adequately measure signal maps in other buildings, experimentation may be necessary to determine the ideal set size. One approach is to first collect training data in a small region of the building under analysis. By observing the mean and standard deviations of this first set of data, one can estimate how many samples are necessary for the system to converge such that the variation of the mean falls below a threshold. The number of collected samples could then exceed this estimated sample threshold. As another example, the mean and standard deviation of collected data could be analyzed in real-time to determine when the standard deviation stabilizes to within a specified threshold. When this occurs, it can be concluded that enough training data has been collected to accurately describe a location.

Another consideration in a localization system is passive localization, which is characterized by the existence of a mobile device as a passive participant in the localization process. Although a device must transmit data to be tracked, the device need not explicitly perform any part of the localization algorithm and the device need not be aware that it is being tracked. Because signal propagation is a reversible operation, the data of a previous created sensor map data should, after calibration, allow someone with access to enough receivers to track any transmitting device. One application of passive localization is for locating an intruder on a wireless Ethernet network.

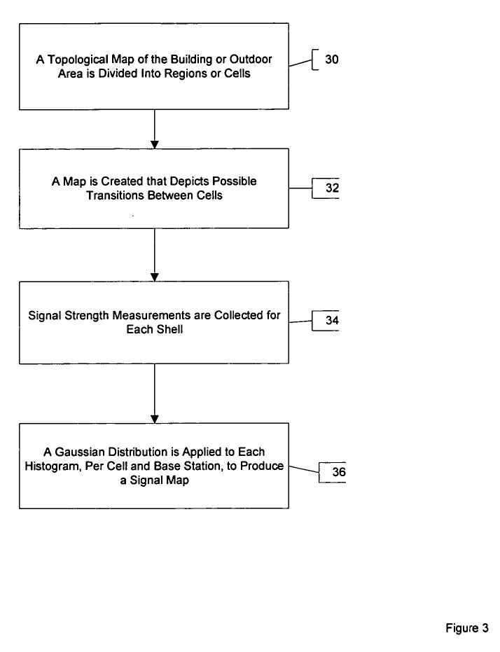

In operation, the training of the localization system described herein involves a series of steps, as set out in FIG. 3. First, at step 30 a topological model of the building or outdoor area under analysis is divided into regions or cells. A map is created at step 32 that depicts all of the possible transitions between the cells. At step 34, signal strength measurements are collected for each cell. A Gaussian distribution is applied at step 36 to each signal strength histogram, per cell and base station, to produce a signal map.

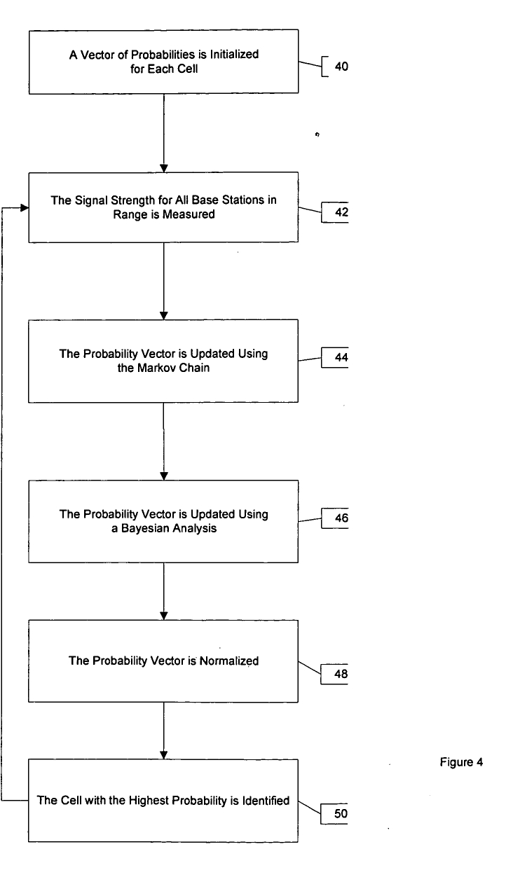

Following the creation of the signal map, the signal map can be used to predict the location of a wireless device. The steps for predicting the location of a wireless device are set out in FIG. 4. At step 40, a vector of probabilities is initialized for each cell. The probability vector is initialized with a uniform distribution. The signal strength for all base station in range is measured at step 42. At step 44, the probability vector is updated using the Markov chain, and, at step 46, the probability vector is updated using the Bayesian update equation. The probability vector is normalized at step 48, and the cell with the highest probability is determined at step 50. As indicated in FIG. 4, steps 42 through 50 can be continually repeated to monitor the movement of the user through the building or outdoor area under analysis.

Although the present disclosure has been described in detail, it should be understood that various changes, substitutions, and alterations can be made hereto without departing from the spirit and the scope of the invention as defined by the appended claims.

What is claimed is:

1. A method for identifying the location of a device in a building, device in a defined area, comprising the steps of:
creating a signal map, wherein the signal map is created by recording a set of wireless signal intensities for a set of regions or offices in the building, and wherein each set of signal intensities is fitted to a Gaussian distribution;
receiving at the device a signal; and
comparing the signal to the set of Gaussian distributions to identify the location of the device in the building.

2. The method for identifying the location of a device of claim 1,
further comprising the step of creating a map of possible transitions between cells; and
wherein the step of comparing the signal to the set of Gaussian distributions to identify the location of the device in the building comprises the step of using the map of possible transitions for the purpose of location of a mobile wireless device.

3. The method for identifying the location of a device of claim 1, further comprising the step of calibrating the signal received at the device to account for differences between the measured signal intensities and the intensity of the signal received at the device.

4. The method for identifying the location of a device of claim 1, further comprising the step of calibrating the signal received at the device to account for time-varying phenomena in the building.

5. The method for identifying the location of a device of claim 1, wherein the step of receiving a signal from a device comprises the step of identifying at the device a signal strength measurement for each base station within range of the device.

6. The method for identifying the location of a device of claim 5, wherein the step of comparing the signal to the set of Gaussian distributions to identify the location of the device in the building, comprises the steps of:
using a probabilistic technique to estimate the likelihood of the Gaussian distribution being present in a cell of the building; and
selecting the cell of the building associated with the greatest likelihood of the Gaussian distribution being present in a cell of the building.

7. The method for identifying the location of a device of claim 6, wherein the probabilistic technique involves a Bayesian analysis.

8. The method for identifying the location of a device of claim 1, further comprising the steps of:
creating a map of possible transitions between cells;
calibrating the signal received at the device to account for differences between the measured signal intensities and the intensity of the signal received at the device; and
calibrating the signal received at the device to account for time-varying phenomena in the building.

9. A method for identifying the location of a wireless device in a defined area, comprising the steps of:
dividing the defined area into a number of cells;
within each cell, measuring the strength of a signal received from each of a number of base stations;
calculating a statistical representation of the measured signal strength for each cell with respect to each base station within range of the cell;
receiving at the wireless device a signal from a number of base stations and generating a signal strength reading; and
identifying the cell of the wireless device through a comparison of the signal strength reading at the device with the calculated statistical representations of the measured signal strengths for each cell.

10. The method for identifying the location of a wireless device in a defined area of claim 9, wherein the defined area comprises a building.

11. The method for identifying the location of a wireless device in a defined area of claim 9, wherein the defined area comprises an outdoor area.

12. The method for identifying the location of a wireless device in a defined area of claim 9, wherein the step of calculating a statistical representation of the measured signal strength for each cell with respect to each base station within range of the cell comprises the step of calculating a Gaussian fit for each cell with respect to each base station within range of the cell.

13. The method for identifying the location of a wireless device in a defined area of claim 9, wherein the step of identifying the cell of the wireless device through a comparison of the signal strength reading at the device with the calculated statistical representations of the measured signal strengths for each cell comprises the step of performing a probabilistic determination to identify the cell that most likely includes the wireless device.

14. The method for identifying the location of a wireless device in a defined area of claim, wherein the probabilistic determination involves a Bayesian analysis.

15. The method for identifying the location of a wireless device in a defined area of claim 9, further comprising the step of calibrating the signal received at the wireless device to account for differences between the wireless device and the device used to measure the signal strength in each cell of the defined area.

16. The method for identifying the location of a wireless device in a defined area of claim 9, further comprising the steps of:
defining possible transitions between cells; and
identifying the cell of the wireless device through an analysis of the defined transitions between cells.

17. A method for identifying the location of a wireless device in a defined area having a number of defined cells, wherein each cell is associated with a reference signal strength, comprising the steps of:
receiving at the wireless device a signal from a number of base stations and generating a signal strength reading;
comparing the signal strength reading to the reference signal and adjusting the signal strength reading on the basis of the comparison;
identifying the cell of the wireless device through a comparison of the adjusted signal strength reading with a set of calculated statistical representations of the reference signal strengths for each cell.

18. The method for identifying the location of a wireless device of claim 17, wherein the calculated statistical representations of the reference signal strengths for each cell comprise a Gaussian statistical fit.

19. The method for identifying the location of a wireless device of claim 17, wherein the step of identifying the cell of the wireless device through a comparison of the adjusted signal strength reading with a set of calculated statistical representations of the reference signal strengths for each cell comprises the step of performing a probabilistic determination to identify the cell that most likely includes the wireless device.

20. The method for identifying the location of a wireless device of claim 18, wherein the probabilistic determination involves a Bayesian analysis.
